(19) United States
(12) Patent Application Publication
(10) Pub. No.: US 2013/0170568 A1
(43) Pub. Date: Jul. 4, 2013

(54) REDUCING INTER-CARRIER INTERFERENCE IN OFDM AND OFDMA SYSTEMS BY TIME SAMPLE SCALING BASED ON CYCLIC PREFIX SAMPLES

(71) Applicants: Assaf Prihed, Ness Zionna (IL); Eran Goldstein, Ra'anana (IL)

(72) Inventors: Assaf Prihed, Ness Zionna (IL); Eran Goldstein, Ra'anana (IL)

(21) Appl. No.: 13/339,575

(22) Filed: Dec. 29, 2011

(51) Int. Cl. H04L 27/28

(52) U.S. Cl. 375/260

(57) ABSTRACT

In described embodiments, an orthogonal frequency multiplexing (OFDM) system reduces inter-carrier interference (“ICI”) of a received signal. In general, the ICI is reduced, within software, hardware, or both, by scaling of receive samples according to scaling factors derived from cyclic prefix samples and correlated samples in a received OFDM symbol.

### BACKGROUND OF THE INVENTION

### Description of the Related Art

Orthogonal frequency multiplexing (OFDM) schemes, such as orthogonal frequency multiple access (OFDMA) communication systems, employ sets of orthogonal sub-carriers for simultaneous transmission of data, which together form OFDM symbols. Typically, such systems group data into blocks (which might represent constellation points modulated with data bits) and then apply an Inverse Discrete Cosine Transform (IDCT) or the faster Inverse Fast Fourier Transform (IFFT) to produce the OFDM symbol. The receiver, which receives the transmitted OFDM symbols, detects the symbol block and applies the Discrete Cosine Transform (DCT) or the faster Fast Fourier Transform (FFT) to the symbol block to produce the recovered data.

In order to prevent interference between OFDM symbols as they are transmitted through the communication medium, the symbols are typically separated by a guard band (or “guard interval” (GI)) to eliminate this inter-block interference (IBI). While early systems simply placed a null space in this interval, present systems insert a cyclic prefix (CP) as the guard interval to provide for fully-loaded OFDM modulation The CP can take several forms, but is usually a copy of the partial waveform (typically the end-portion of the waveform).

Inter-carrier interference ICI represents a form of power leakage among different sub-carriers within OFDMIOFDMA communication systems. ICI sources based on temporal variations of the channel may include carrier frequency offsets, Doppler spread, sampling frequency offsets, phase noise, and other sources. Further, an insufficient CP or GI might be a source of ICI if there is excess delay of the channel. ICI is often modeled as a linear-frequency-invariant function, acting on the frequency domain representation of the OFDM transmitted symbol.

ICI is a well known cause of degraded performance of OFDM and OFDMA communication systems, such as, for example, 3GPP LTE (“long term evolution”) for cellular telephony and IEEE 802.11, 802.15 and 802.16 compliant communication systems, such as WiMax. Previous attempts to decrease ICI or to decrease its impact on the error rate of the transmitted symbol stream have included decreasing the bits/symbols of the modulation scheme in order to increase the minimal noise required to cause an error, increasing the coding rate to better handle higher soft bit error rate, and changing the transmission scheme by mapping each data symbol into two or more adjacent pairs of subcarriers rather than onto a single subcarrier. These methods for reducing effects of ICI, however, entail decreasing transmission bandwidth while also requiring changes in the transmitter.

More recently, attempts to provide self-cancellation of ICI at the receiver have been developed. Self-cancellation attempts to estimate the transfer function of the communication channel. Once estimated, an inverse of the transfer function can be applied to reduce channel effects, similar to the techniques employed for feed forward and decision feedback equalization. One method employs an estimate derived from pilot signals used by the OFDM/OFDMA communication system to synchronize the decoding operation at receivers. However, this method is not optimal because the pilot signals pass through a slightly different channel transfer function than the data stream channel, causing errors in the estimated parameters. Another method inserts specific bit sequences or code sequences into the data stream for use by a receiver's estimation algorithm(s). However, this method adds extra data for transmission, reducing the user data throughput of the system channel.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, the present invention reduces inter-carrier interference in a signal received from a channel by detecting a cyclic prefix of an OFDM symbol having beginning portion and an ending portion, the cyclic prefix being within the end portion of the OFDM symbol; and comparing the beginning portion of the OFDM symbol and the cyclic prefix at the ending portion of the OFDM symbol. Fading changing rate parameters are derived for the comparison of the beginning and the cyclic prefix at the ending portion of the OFDM symbol. An interpolation is performed using the derived parameters, thereby estimating an inverse fading scalar for each time sample; and each time sample on the OFDM symbol is multiplied by the inverse fading scalar, yielding a reduced ICI influence. A frequency domain transform is performed on the OFDM symbol to generate a constant fading; and the constant fading is removed from the OFDM symbol.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 illustrates exemplary signal degradation of a signal caused by ICI that might be received by a device employing one or more embodiments of the present invention;

FIG. 2 shows a pair of OFDM symbols each incorporating a CP according to an exemplary embodiment of the present invention;

FIG. 3 shows a flowchart illustrating an exemplary method in accordance with an exemplary embodiment of the present invention;

FIG. 4 s illustrates the method of FIG. 3 employed to generate uniform fading throughout an entire OFDM symbol; and

FIG. 5 shows a schematic illustration of a system adding the CP prior to transmission of the signal and removing the ICI after transmission according to an exemplary embodiment of the present invention.

### DETAILED DESCRIPTION

In accordance with embodiments of the present invention, a receiver of an OFDM system reduces ICI of a received signal. In general, the method entails, within software, hardware, or both, scaling of receive samples according to scaling factors derived from cyclic prefix samples and correlated samples in a received OFDM symbol. ICI might be reduced by performing an embodiment of the present invention in either software or hardware, in which an OFDM signal is wirelessly transmitted through a channel from a first device, such as a transmitter, to a second device, such as a receiver. The effect of ICI to a signal in the time domain might be modeled as “fading”, which is a multiplication of each sample in the time domain by a corresponding sample-specific complex scalar related to a transfer function of the wireless channel. Multiplying time-domain samples at the receiver by a scaling factor, such as a value representing an inverse of the fading scalar (termed herein as an “inverse fading scalar”) might be employed to reduce or cancel effects of the fading.

The present invention might provide the following advantages. Reducing ICI while maintaining transmission bandwidth provides for higher data-throughput and reduced error rate. Since a CP is currently generated and used for the GI, existing information is employed for self-cancellation of ICI, without adding overhead data or generating estimates from a different channel. In addition, devices employing one or more embodiments of the present invention might not require changes to transmission system hardware, and so might also be backwardly compatible with existing systems

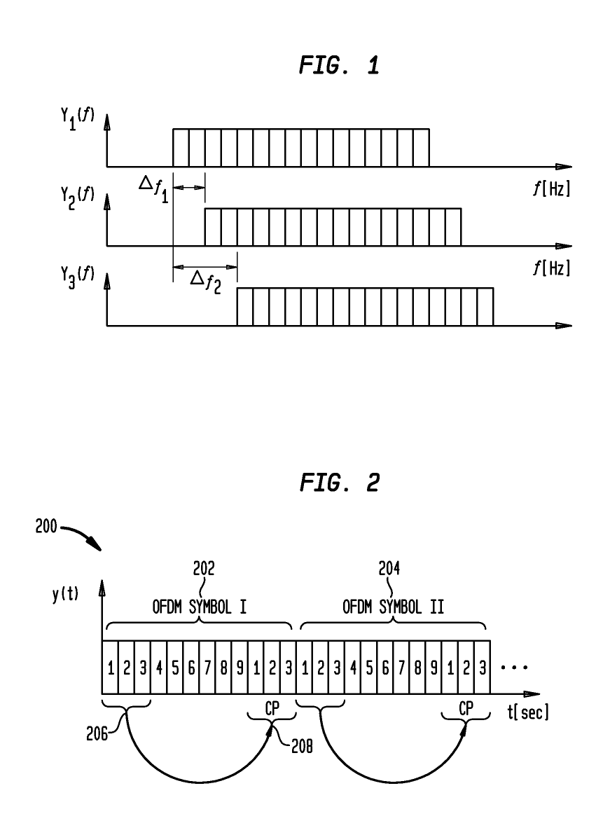

Exemplary signal degradation of a signal caused by ICI that might be received by a device employing one or more embodiments of the present invention is illustrated FIG. 1. In FIG. 1, a sequence of three frequency-domain OFDM symbols Y₁(f), Y₂(f) and Y₃(f) are received Due to temporal or other variations of the channel, Y₂(f) is phase/frequency shifted from Y₁(f) by Δf₁. Similarly, Y₃(f) is shifted from Y₁(f) by Δf₂. Since these sub-carriers of Y₁(f), Y₂(f) and Y₃(f) are now modified in frequency and phase, they are not necessarily orthogonal to one another, causing ICI interference, and, thus, adding noise during the decoding process of the receiver.

In systems, such as OFDM and OFDMA communication systems, a CP is added to the beginning portion or ending portion of each transmitted sequence, as shown in FIG. 2. The CP is usually an exact replica of the last part of the OFDM symbol, which is transmitted before the beginning of the next OFDM symbol. In order to obtain the correct scaling factors, the CP and its corresponding samples at the beginning of an OFDM symbol are employed by embodiments of the present invention.

Due to the CP transmission, the same data is transmitted at both the beginning portion and an ending portion of the OFDM symbol. Because the same data is transmitted at the beginning portion and at the ending portion of the OFDM symbol, the change in the fading between the beginning portion of the OFDM symbol and the ending portion of the OFDM symbol might be estimated by comparing the data at the beginning portion and the ending portion of the OFDM symbol. Parameters, known herein as “derived parameters”, to describe the fading changing rate are derived from such comparison. Because the fading is a continuous and slow-changing process, a reliable interpolation can be performed using the derived parameters in order to estimate the inverse fading scalars for each time sample. ICI might then be reduced by multiplying each time sample by its inverse scalar before performing a Discrete Cosine Transform (DCT), a Fourier Transform, or a Fast Fourier Transform (FFT). That way, a close to constant fading is generated, which can easily be equalized in the frequency domain by known methods.

In application of the present invention, referring to FIG. 2, two OFDM symbols 202, 204 in a transmission sequence 200 are shown. Those skilled in the art, however, will recognize that the transmission sequence may have more than the two illustrated OFDM symbols 202, 204. For simplicity, only OFDM symbol 202 will be discussed. OFDM symbol 202 incorporates nine elements, which are numbered 1-9. The first three elements, numbered 1-3, constitute a beginning portion 206 of OFDM symbol 202. OFDM symbol 202 is generated by applying an inverse frequency domain transform to a block of data. In an exemplary embodiment, the inverse frequency domain transform may be one of an inverse DCT, an inverse Fourier Transform and an inverse FFT.

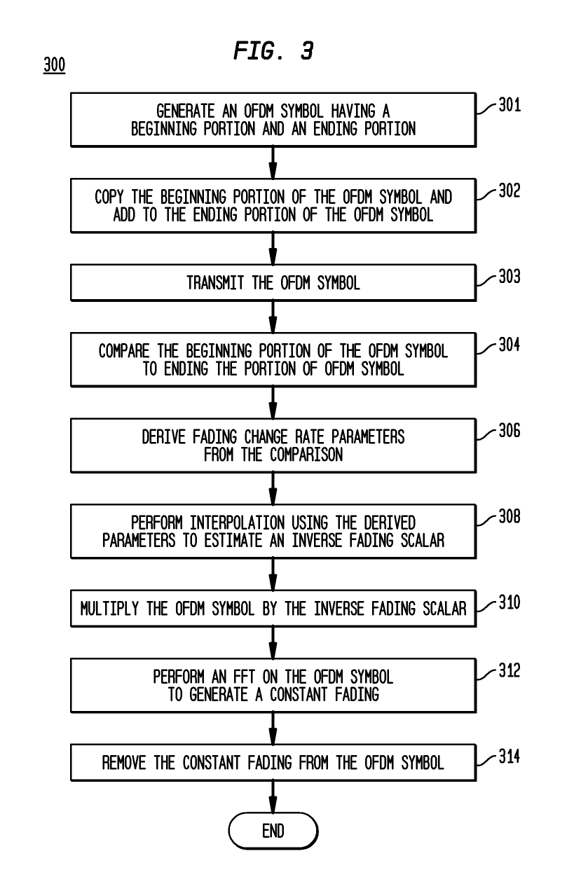

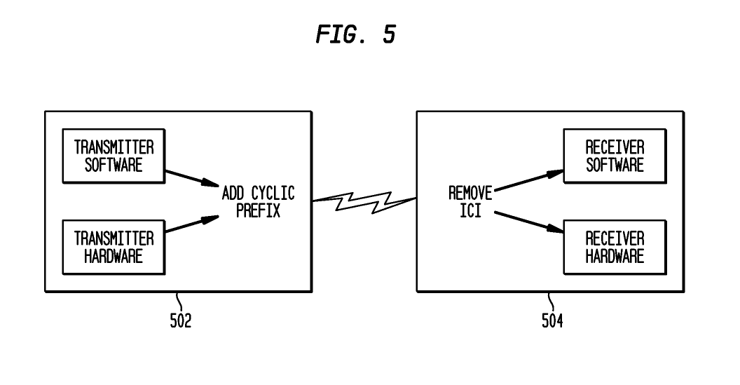

Referring to flowchart 300 in FIG. 3, in step 301, OFDM symbol 202 having beginning portion 206 and ending portion 208 is generated, such as by a transmitter 502, shown schematically in FIG. 5. In step 302, the beginning portion 206 (i.e. elements 1-3) is copied and added to ending portion 208 of OFDM symbol 202, forming a CP, resulting in a 12-element modified OFDM symbol 202. The CP is an exact replica of the beginning portion 206. Given that transmission of the CP reduces the data rate, it may be desired to minimize the CP duration. In an exemplary embodiment, the CP is between approximately 10% and approximately 35% of the symbol time, prior to appending the CP to the modified OFDM symbol 202.

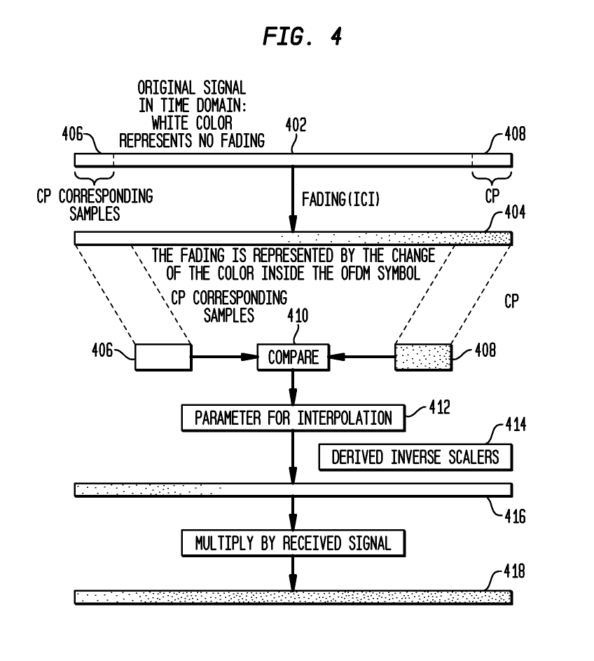

In FIG. 4, modified OFDM symbol 202 is represented by a transmitted OFDM symbol bar 402 in a time domain, with beginning portion 206 represented by a beginning bar portion 406 and ending portion 208 being represented by an ending bar portion 408. Bar 402 has no color shading, which represents an absence of fading of OFDM symbol 202. The introduction of fading to modified OFDM symbol 202 is represented by color shading in bar 404.

In step 303, and as shown in FIG. 5, modified OFDM symbol 202 is wirelessly transmitted from transmitter 502 in a first location and received by a receiver 504 as transmitted OFDM symbol 202 in a second location. The method of transmitting modified OFDM symbol 202 from transmitter 502 to receiver 504 is performed as steps of a processor of a wireless handset operating in accordance with at least one of 3G, IEEE 802.11, IEEE 802.15, and 802.16 communication standard.

In step 304, beginning portion 406 of OFDM bar 402 is compared to ending portion 408 of OFDM bar 402. The comparison is shown in block 410 in FIG. 4. Based on the comparison, in step 306, fading changing rate parameters, shown in block 412 in FIG. 4, are derived. An example for such a parameter might be any kind of average of the ratio between value or amplitude, or phase difference, of the samples in the CP and its corresponding samples in the OFDM symbol. The fading changing rate parameters are related to a transfer function of the channel in which the signal is received. Since fading of an OFDM symbol is a continuous and slow-changing process, a reliable interpolation might be performed using the derived parameters in order to estimate the inverse fading scalars for each time sample.

In step 308, the interpolation is performed using the derived parameters 414 to estimate an inverse fading scalar. In step 310, the transmitted OFDM symbol 202 is multiplied by its inverse fading scalar, represented by bar 416 in FIG. 4, resulting in transmitted OFDM symbol 202 with a generally closer to uniform, constant fading throughout, as represented by bar 418.

In step 312, a frequency domain transform is performed on transmitted OFDM symbol 202 to generate the constant fading and, in step 314, the constant fading is removed from transmitted OFDM symbol 202. In an exemplary embodiment, the frequency domain transform may be one of a DCT, a Fourier Transform and an FFT.

Optionally, steps 301-314 might be performed in hardware (i.e. the transmitter 502 and the receiver 504) or software. If steps 301-314 are performed in hardware, then steps 301 and 302 are performed in transmitter 502 and steps 304-314 are performed in receiver 504, with the OFDM symbol 202 being transmitted from transmitter 502 to receiver 504 in step 303.

While, in the exemplary embodiment discussed above, elements 1-3 are copied from the beginning portion 206 of OFDM symbol 202 and added to the ending portion 208 of OFDM symbol 202, those skilled in the art will recognize that elements 7-9 might be copied from the ending portion 208 of OFDM symbol 202 and added to the beginning portion 206 of OFDM symbol 202. The present invention requires only that the beginning portion 206 of OFDM symbol 202 be identical to ending portion 208 of OFDM symbol 202.

According to the present invention, reduction of the effects of ICI might be implemented as a relatively fast, low-consultation cost algorithm. Embodiments of the present invention might handle any number of Doppler shifts. Additionally, the inventive method does not require frequency conversions and no iterations are required, resulting in a simpler and more efficient algorithm without decreasing the data bit transmission rate or requiring any changes at the transmitter.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

The present invention may be implemented as circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

Unless explicitly stated otherwise, each numerical value and range should be interpreted as being approximate as if the word “about” or “approximately” preceded the value of the value or range.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

It will be further understood that various changes in the details, materials, and arrangements of the parts which have been described and illustrated in order to explain the nature of this invention may be made by those skilled in the art without departing from the scope of the invention as expressed in the following claims.

We claim:

1. A method of reducing inter-carrier interference in a signal received from a channel, the method comprising:
detecting a cyclic prefix of an orthogonal frequency division multiplexing (“OFDM”) symbol having beginning portion and an ending portion, the cyclic prefix being within the end portion of the OFDM symbol;
comparing the beginning portion of the OFDM symbol and the cyclic prefix at the ending portion of the OFDM symbol;
deriving fading changing rate parameters for the comparison of the beginning and the cyclic prefix at the ending portion of the OFDM symbol;
performing an interpolation using the derived parameters, thereby estimating an inverse fading scalar;
multiplying the OFDM symbol by the inverse fading scalar;
performing a frequency domain transform on the OFDM symbol to generate a constant fading; and
removing the constant fading from the OFDM symbol.

2. The method according to claim 1, wherein, for the step of detecting the cyclic prefix, the cyclic prefix is a replica of the beginning portion of the OFDM symbol.

3. The method according to claim 1, wherein the method is performed as steps of a processor of a wireless handset operating in accordance with at least one of 3G, IEEE 802.11, IEEE 802.15, and 802.16 communication standard.

4. The method according to claim 3, wherein for the step of deriving fading changing rate parameters, the parameters are related to a transfer function of the channel.

5. The method according to claim 4, wherein the frequency domain transform is at least one of a Discrete Cosine Transform, a Fourier Transform and a Fast Fourier Transform.

6. The method according to claim 1, wherein the method is performed in software.

7. The method according to claim 6, wherein the method is performed in a receiver.

8. A method of generating an OFDM symbol for user data, the method for reducing inter-carrier interference in a wireless electronic signal carrying the OFDM symbol through a channel, the method comprising:
generating, by applying an inverse frequency domain transform to a block of data, an orthogonal frequency division multiplexing (“OFDM”) symbol having a beginning portion and an ending portion;
generating a cyclic prefix for the OFDM symbol; and
modifying the OFDM symbol in a transmission sequence such that the beginning portion of the modified OFDM symbol is substantially equivalent to the ending portion of the modified OFDM symbol with the cyclic prefix as the ending portion of the modified OFDM symbol;
wherein the step of generating the cyclic prefix generates a relatively short cyclic prefix between approximately 10% and approximately 35% of a time of the OFDM symbol prior to modifying the OFDM symbol by the cyclic prefix.

9. The method according to claim 8, further comprising transferring the modified OFDM symbol via a wireless electronic signal through the channel to a receiver.

10. The method according to claim 9, further comprising reducing, by the receiver of the transferred OFDM symbol, the inter-carrier interference applied to the transferred OFDM symbol by the channel, the reducing step comprising:
comparing the beginning portion and the ending portion of the modified OFDM symbol;
deriving fading changing rate parameters for the comparison of the beginning portion and the ending portion of the transferred OFDM symbol;
performing an interpolation using the derived parameters thereby estimating an inverse fading scalar;
multiplying the transferred OFDM symbol by the inverse fading scalar;
performing a frequency domain transform on the transferred OFDM symbol to generate a constant fading; and
removing the constant fading from the transferred OFDM symbol.

11. The method according to claim 10, wherein for the step of deriving fading changing rate parameters, the parameters are related to a transfer function of the channel.

12. The method according to claim 8, wherein the method is performed as steps of a processor of a wireless base station operating in accordance with at least one of 3G, IEEE 802.11, IEEE 802,15, and 802.16 communication standard.

13. The method according to claim 8, wherein the inverse frequency domain transform is at least one of an inverse Discrete Cosine Transform, an inverse Fourier Transform and an inverse Fast Fourier Transform.

14. A non-transitory machine-readable storage medium, having encoded thereon program code, wherein, when the program code is executed by a machine, the machine implements a method for generating an orthogonal frequency division multiplexing (“OFDM”) symbol for user data, the method for reducing inter-carrier interference in a wireless electronic signal transferring the OFDM symbol through a channel, comprising the steps of:
detecting a cyclic prefix of an OFDM symbol having beginning portion and an ending portion, the cyclic prefix within the end portion of the OFDM symbol;
comparing the beginning portion of the OFDM symbol and the cyclic prefix at the ending portion of the OFDM symbol;
deriving fading changing rate parameters for the comparison of the beginning and the cyclic prefix at the ending portion of the OFDM symbol;
performing an interpolation using the derived parameters, thereby estimating an inverse fading scalar;
multiplying the OFDM symbol by the inverse fading scalar;
performing a frequency domain transform on the OFDM symbol to generate a constant fading; and
removing the constant fading from the OFDM symbol.
